(19) United States
(12) Patent Application Publication
(10) Pub. No.: US 2025/0108653 A1
(43) Pub. Date: Apr. 3, 2025

(54) PRINTING APPARATUS, CONTROL METHOD, AND STORAGE MEDIUM

(71) Applicant: CANON KABUSHIKI KAISHA, Tokyo (JP)

(72) Inventors: TAKESHI YAZAWA, Kanagawa (JP); SATOSHI WADA, Tokyo (JP); NAOKO BABA, Kanagawa (JP); JUMPEI JOGO, Tokyo (JP); SHINGO NISHIOKA, Kanagawa (JP); KEIJI KURIYAMA, Saitama (JP); SERENA SAITO, Kanagawa (JP)

(21) Appl. No.: 18/904,670

(22) Filed: Oct. 2, 2024

(30) Foreign Application Priority Data
Oct. 3, 2023 (JP) 2023-172196

(51) Int. Cl. B41J 29/393; H04N 1/00

(52) U.S. Cl. CPC B41J 29/393; H04N 1/00344

(57) ABSTRACT

One embodiment is a printing apparatus comprising: a conveyance unit configured to convey a printing medium in a conveyance direction; and a printing head configured to eject a liquid, and being capable of conducting a maintenance control on the printing head while temporarily pausing a printing operation and configured to execute tiled printing of printing an image in which a plurality of printed products obtained by printing are assumed to be arranged adjacent to each other, while dividing the image into a plurality of pages including at least a first page and a second page, wherein the printing apparatus is configured to control whether or not to conduct the maintenance control based on a conveyance-direction distance from a top of the page along the conveyance direction for the page during printing in a case of executing the tiled printing and printing each of the plurality of pages.

### BACKGROUND

### Field

The present disclosure relates to a technique of reducing density unevenness in a tiled-print product.

### Description of the Related Art

A printing apparatus which prints an image on a printing medium by ejecting an ink from a printing head onto the printing medium has been known. In these years, the usages of printing apparatuses have been widened from personal documents and pictures to posters for commercial use and sign posting products. Regarding sign posting products, an increase in size of images to be printed has been demanded, along with this, the sizes of printing apparatuses have been increasing. As a method which meets the demand for an increase in size of images, a printing method called “tiling” has been known, which is capable of obtaining an image having a size larger than the size of a printing medium set in a printing apparatus, by joining printed images.

In the case where tiling is not conducted, density unevenness is unlikely to be visually recognized. However, in the case where tiling is conducted, there is a case where density unevenness is noticeable in a joint portion as printed images are joined. For the problem that density unevenness which is visually recognized is generated in a joint portion due to density variation associated with an increase in temperature of a printing head during printing, Japanese Patent Laid-Open No. 2004-122637 discloses a method for suppressing the density unevenness.

However, even in the case where density variation associated with an increase in temperature of a printing head or density unevenness can be suppressed by using the technique of Japanese Patent Laid-Open No. 2004-122637, density unevenness in a joint portion is noticeable due to other factors in some cases. For example, in the case where a predetermined maintenance control which is conducted while a printing operation is paused is conducted during image printing, variation in image quality is generated due to the pause of the print scan, resulting in noticeable density unevenness in some cases.

### SUMMARY

In view of the above problem, an object of the present disclosure is to suppress density unevenness in a joint portion at the time of tiled printing even in the case of conducting a predetermined maintenance control while pausing a printing operation during image printing.

One embodiment of the present disclosure is a printing apparatus comprising: a conveyance unit configured to convey a printing medium in a conveyance direction; and a printing head configured to eject a liquid, and being capable of conducting a maintenance control on the printing head while temporarily pausing a printing operation and configured to execute tiled printing of printing an image in which a plurality of printed products obtained by printing are assumed to be arranged adjacent to each other, while dividing the image into a plurality of pages including at least a first page and a second page, wherein the printing apparatus is configured to control whether or not to conduct the maintenance control based on a conveyance-direction distance from a top of the page along the conveyance direction for the page during printing in a case of executing the tiled printing and printing each of the plurality of pages.

Further features of the present disclosure will become apparent from the following description of exemplary embodiments with reference to the attached drawings.

### BRIEF DESCRIPTION OF THE DRAWINGS

FIG. 1 is a perspective view of a printing apparatus;

FIG. 2 is a side view of the printing apparatus;

FIG. 3 is a schematic diagram of a printing head;

FIG. 4 is a side view of a recovery processing apparatus;

FIG. 5 is a side view of the recovery processing apparatus;

FIG. 6 is a block diagram showing a configuration of a control system of the printing apparatus;

FIG. 7 is a schematic diagram showing multi-path printing;

FIG. 8A and FIG. 8B are schematic diagrams showing mask patterns;

FIG. 9 is a flowchart of image processing;

FIG. 10 is a schematic diagram showing a graphical user interface screen;

FIG. 11A and FIG. 11B are schematic diagrams showing print scan pause unevenness;

FIG. 12 is a schematic diagram showing a tiled-print product;

FIG. 13A and FIG. 13B are schematic diagrams showing print scan pause unevenness;

FIG. 14 is a flowchart of page printing processing;

FIG. 15 is a flowchart of page printing processing;

FIG. 16A and FIG. 16B are schematic diagrams showing positions at which printing pause is conducted;

FIG. 17 is a schematic diagram showing a tiled-print product;

FIG. 18 is a schematic diagram showing a graphical user interface screen;

FIG. 19 is a flowchart of page printing processing;

FIG. 20A to FIG. 20D are schematic diagrams showing positions at which printing pause is conducted;

FIG. 21 is a schematic diagram showing a tiled-print product;

FIG. 22 is a schematic diagram showing a graphical user interface screen;

FIG. 23 is a schematic diagram showing print scan pause unevenness;

FIG. 24 is a flowchart of page printing processing;

FIG. 25 is a flowchart of page printing processing;

FIG. 26A to FIG. 26D are schematic diagrams showing positions at which printing pause is conducted; and

FIG. 27 is a schematic diagram showing a graphical user interface screen.

### DESCRIPTION OF THE EMBODIMENTS

Hereinafter, embodiments according to the present disclosure will be described in detail with reference to the drawings.

### First Embodiment

### <Configuration of Inkjet Printing Apparatus>

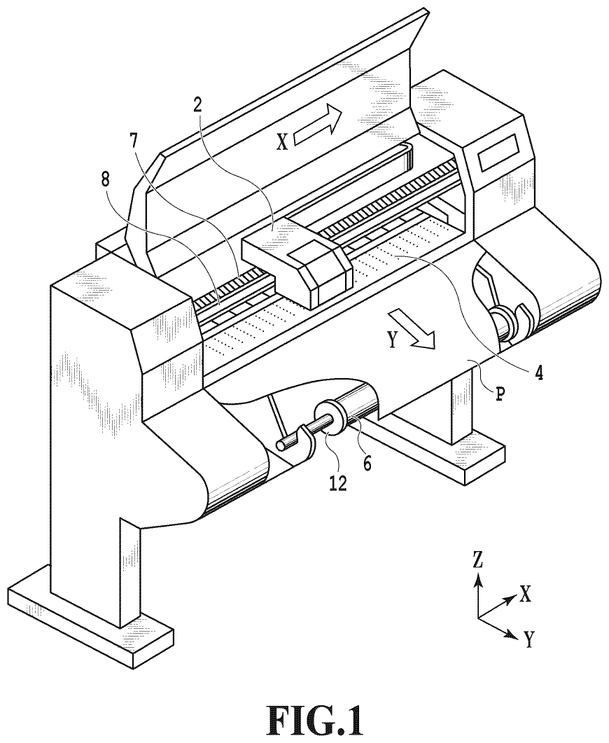

Hereinafter, an overview of a configuration and an operation in printing of an inkjet printing apparatus (hereinafter, also referred to as a printing apparatus and a printer) according to the present embodiment will be described by using FIG. 1 to FIG. 3. FIG. 1 is a perspective view showing an appearance of the printing apparatus. This printing apparatus is a so-called serial scan-type printer and prints an image by causing a printing head to scan in an X-direction which is orthogonal to a direction in which a printing medium P is conveyed (which is defined as a Y-direction and a conveyance direction in the drawings). Note that the X-direction in which the printing head is caused to scan is defined as a scanning direction, and a Z-direction is defined as a height direction.

In the printing operation, a conveyance roller which is driven by a conveyance motor, which is not shown, via gears is rotated such that the printing medium P is conveyed in the Y-direction by a winding spool 12 which is holding the printing medium P. Once the printing medium P reaches a predetermined conveyance position, a carriage unit 2 is reciprocated by a carriage motor, which is not shown, along a guide shaft 8 which extends in the X-direction (scan conducted by this reciprocation is referred to as “reciprocating scan”). Then, in the course of this reciprocating scan, an ejection operation is conducted from ejection ports of the printing head mounted on the carriage unit 2 at a timing based on a position signal obtained by a linear encoder 7 to print an image having a constant band width corresponding to a range of array of the ejection ports. Note that the present example is assumed to be configured to conduct scan at a scan rate of 45 inch per second and conduct the ejection operation at a resolution of 1200 dpi (1/1200 inch). After an image having the constant band width is printed, the printing medium P is conveyed, and the next band width is printed, and thereafter, the conveyance of the printing medium P and the printing of an image having the constant band width are repeated. Note that the carriage unit 2 can also conduct scan at a speed of 45 inch per second or more.

For the transmission of drive force from the carriage motor to the carriage unit 2, a carriage belt is used. Note that instead of the carriage belt, it is possible to employ another drive system such as a system including a leadscrew which extends in the X-direction and is rotationally driven by the carriage motor and an engagement portion which is provided in the carriage unit 2 and engages with a groove of the leadscrew, for example.

The printing medium P thus fed is pinched and conveyed by a feeding roller and a pinch roller and is guided to a printing position on a platen 4 (a position at which the printing head can print in a scanning region of the printing head). Since in the state of pause, the face surface of the printing head is normally capped, the cap is opened to bring the printing head and the carriage unit 2 into a state of being capable of scanning before printing. Thereafter, once data for one scan is accumulated in a buffer, the carriage unit 2 is caused to scan by the carriage motor to conduct printing as mentioned above.

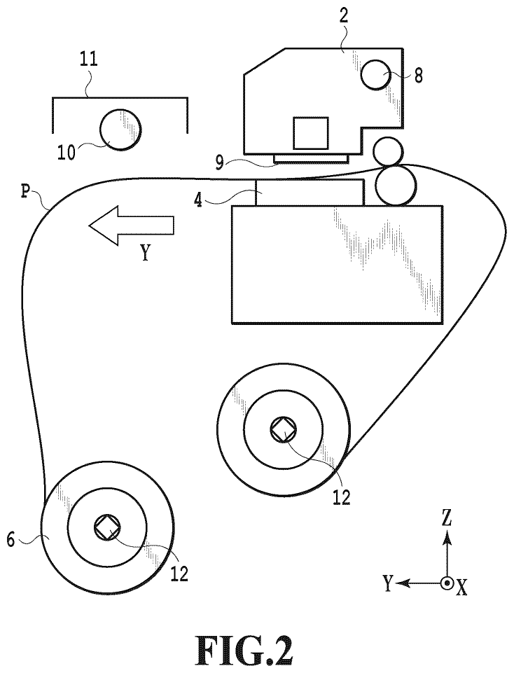

FIG. 2 is a schematic side view of the printing apparatus. A heater 10 which is supported by a frame, which is not shown, is disposed in a curing region located downstream, in the conveyance direction (Y-direction) of the printing medium, of the position at which the printing head 9 mounted on the carriage unit 2 reciprocally scans in the main scanning direction (X-direction). The heater 10 dries an ink in liquid form on the printing medium P by means of heat. The heater 10 is covered with a heater cover 11, and the heater cover 11 performs a function of efficiently applying the heat of the heater 10 onto the printing medium P and a function of protecting the heater 10. After the printing by the printing head 9, the printing medium P is wound by a winding spool 12 located downstream in the conveyance direction of the printing medium to form a wound medium 6 in roll form.

The heater 10 is, for example, a sheathed heater, a halogen heater, or the like. The heating temperature of a heating unit in the curing region is set in consideration of the film formation capability and productivity of a resin emulsion as well as the heat resistance of the printing medium P. Note that as heating means of the heating unit in the curing region, warm air blow heating from above, heating with a contact thermal conduction type heater which comes into contact from below the printing medium, or the like may be employed. In addition, the heating means of the heating unit in the curing region is provided at one position in the present embodiment, but may be provided at two or more positions and used in combination as long as the measurement temperature in a radiation thermometer (not shown) on the printing medium P does not exceed a set value of the heating temperature.

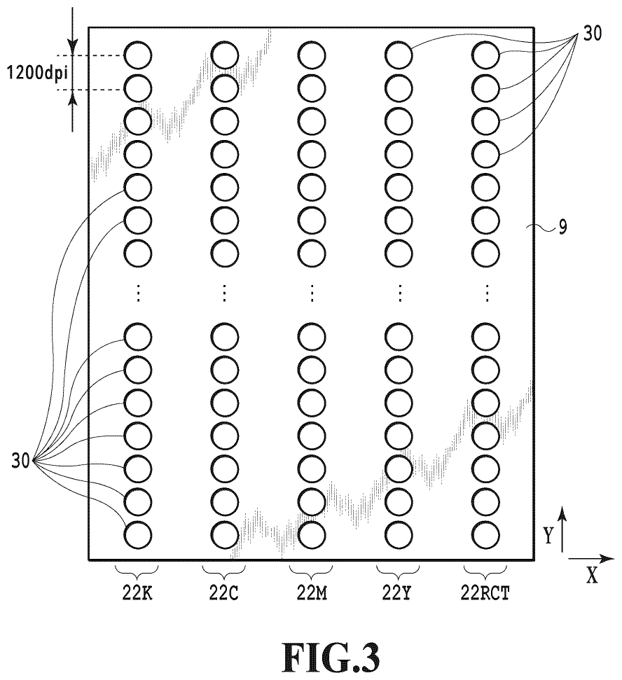

FIG. 3 is a plan view showing the printing head 9 according to the present embodiment. The printing head 9 includes ejection port arrays which eject inks containing color materials. Specifically, the printing head 9 includes an ejection port array 22K which ejects a black ink (K), an ejection port array 22C which ejects a cyan ink (C), an ejection port array 22M which ejects a magenta ink (M), and an ejection port array 22Y which ejects a yellow ink (Y). Since these black ink (K), cyan ink (C), magenta ink (M), and yellow ink (Y) contain color materials, these inks are referred to as color material inks or color inks in the following description.

In addition, the printing head 9 includes an ejection port array 22RCT which ejects a reaction liquid (RCT) which does not contain any color material. This reaction liquid does not contain any color material, but contains a reactive component which reacts with the color materials contained in the color inks, and upon coming into contact with the color ink on the printing medium, can suppress bleeding of the color ink. Note that for the ejection port array 22K, the ejection port array 22C, the ejection port array 22M, and the ejection port array 22Y, in the case where it is unnecessary to consider the difference in color, these ejection ports are collectively referred to as “22COL”. In addition, for the ejection port array 22K, the ejection port array 22C, the ejection port array 22M, the ejection port array 22Y, and the ejection port array 22RCT, in the case where it is unnecessary to consider the difference in color and the presence or absence of the color material, these ejection port arrays are collectively referred to as the “ejection port array 22”.

In the printing head 9, these ejection port arrays are disposed side by side from the upstream side to the downstream side in the X-direction in the order of the ejection port array 22K, the ejection port array 22C, the ejection port array 22M, the ejection port array 22Y, and the ejection port array 22RCT. Each of these ejection port arrays is configured such that 1280 ejection ports 30 which eject a liquid (the ink or the reaction liquid) are arrayed in the Y-direction at a density of 1200 dpi. Note that in the present embodiment, an ejection amount of the liquid (the ink or the reaction liquid) to be ejected from one ejection port 30 at once is about 4.5 pl. Each of the ejection port array 22K, the ejection port array 22C, the ejection port array 22M, the ejection port array 22Y, and the ejection port array 22RCT is connected to a liquid tank which stores the corresponding liquid, which is not shown, and the liquid is supplied from this liquid tank. The configuration may be such that the printing head 9 and the liquid tanks are integrally configured, or may be such that each of these can be separated.

### <Maintenance Unit>

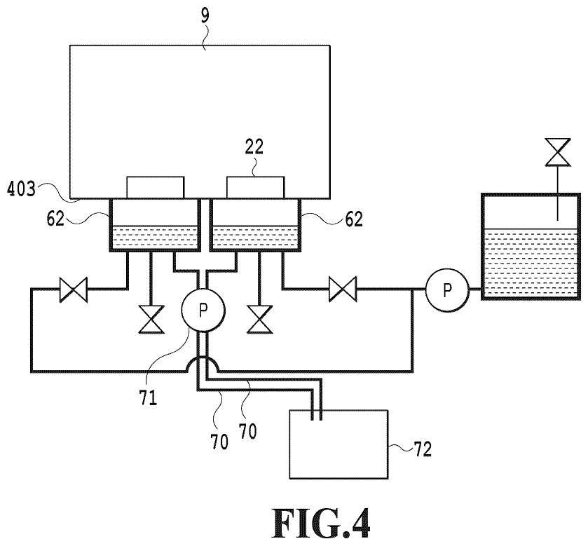

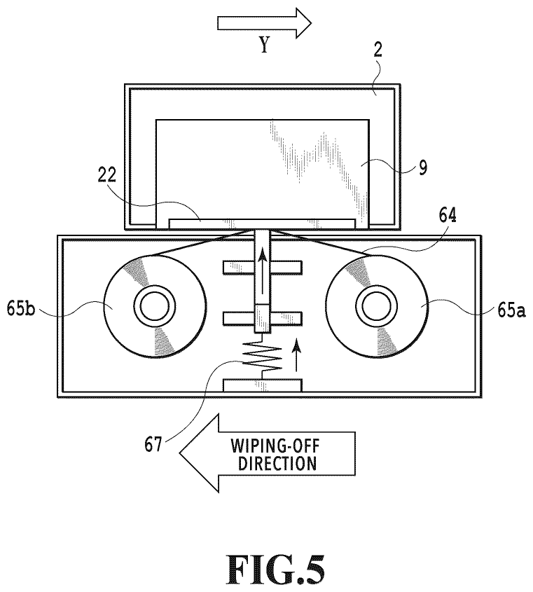

Hereinafter, a maintenance unit will be described by using FIG. 4 and FIG. 5. FIG. 4 is a side view of a recovery processing apparatus according to the present embodiment. The recovery processing apparatus is set at a position at which the recovery processing apparatus faces an ejection port face of the printing head 9 when the carriage 2 supported by the guide shaft 8 has moved to a recovery processing region adjacent to the printing region based on a signal of the linear encoder 7. A cap 62 is brought into close contact with the ejection port face 403 of the printing head 9 such that the ejection port array 22 can be covered with the cap 62 by moving the cap 62 to a high position by using a raising and lowering mechanism, which is not shown. Note that the aforementioned printing region refers to a region which is part of a scanning region of the printing head, where the printing head is capable of printing. The printing head 9 is capable of moving through the printing region and the recovery processing region, which are arranged side by side in the X-direction.

In addition, discharge passages 70 and a discharge pump 71 for discharging the liquid, the air, and the like which have entered the caps 62 are provided for the caps 62. The liquid (for example, a thickening ink), the air, foreign matters, and the like inside the printing head 9 are forcibly discharged by generating a negative pressure inside the caps 62 by using the discharge pump 71, so that the printing head 9 is brought into a state capable of conducting favorable ejection. The liquid and the air discharged by the suction are accumulated in a waste tank 72 through the discharge passages 70.

Besides the suction by the discharge pump 71, a control of preliminarily discharging the ink from the printing head 9 in addition to the usage of printing an image to make the ejection state favorable is conducted during various controls, and this ejection is referred to as “preliminary ejection”. The preliminary ejection can be conducted inside the caps 62, on the printing medium P, or on the platen 4.

FIG. 5 is a side view of a recovery processing apparatus according to the present embodiment, which is a recovery processing apparatus different from FIG. 4. The recovery processing apparatus shown in FIG. 5 is set at a position at which the recovery processing apparatus faces the ejection port face of the printing head 9 when the carriage 2 supported by the guide shaft 8 has moved to a recovery processing region adjacent to the printing region based on a signal of the linear encoder 7. This recovery processing apparatus includes a sheet member 64 capable of wiping off the ink which has adhered to the ejection ports of the printing head 9. The sheet member 64 is biased by a spring 67.

The sheet member 64 unused (before wiping off the ink) is wound around a rotary member 65a. A rotary member 65b is disposed upstream of the rotary member 65a in the Y-direction. To the rotary member 65b, the leading end of the sheet member 64 is attached, and the sheet member 64 used (after wiping off the ink) is wound up by the rotary member 65b driven by the conveyance motor. This enables the vicinity of the ejection ports of the printing head 9 to be wiped clean, allowing the ejection of ink droplets from the ejection ports to be continued with no problem.

### <Control System>

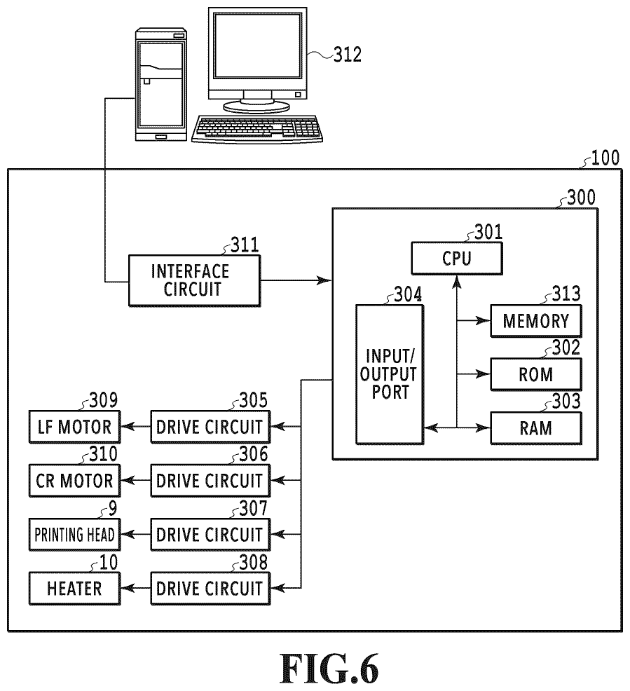

FIG. 6 is a block diagram showing a schematic configuration of a control system in the printing apparatus 100 according to the present embodiment. A main control unit 300 includes a CPU 301, a ROM 302, a RAM 303, an input/output port 304, and a memory 313. The CPU 301 conducts controls of conducting processes such as computation, selection, judgment, and the like, thereby executing the printing operation. The ROM 302 stores a control program which is executed by the CPU 301, and the like. The RAM 303 is used as a buffer for print data, and the like, and temporarily stores volatile data such as the print data.

The input/output port 304 performs a function of transmitting and receiving data between the inside and outside of the main control unit 300. To the input/output port 304, a drive circuit 305, a drive circuit 306, a drive circuit 307, and a drive circuit 308 are connected. The drive circuit 305 drives the conveyance motor (LF motor) 309, the drive circuit 306 drives the carriage motor (CR motor) 310, the drive circuit 307 drives the printing head 9, and the drive circuit 308 drives the heater 10.

In addition, the main control unit 300 is connected to an information processing apparatus (PC) 312 serving as a host terminal via an interface circuit 311. The main control unit 300 receives a print job transmitted by the PC 312 via the interface circuit 311 and the input/output port 304.

### <Multi-Path Printing>

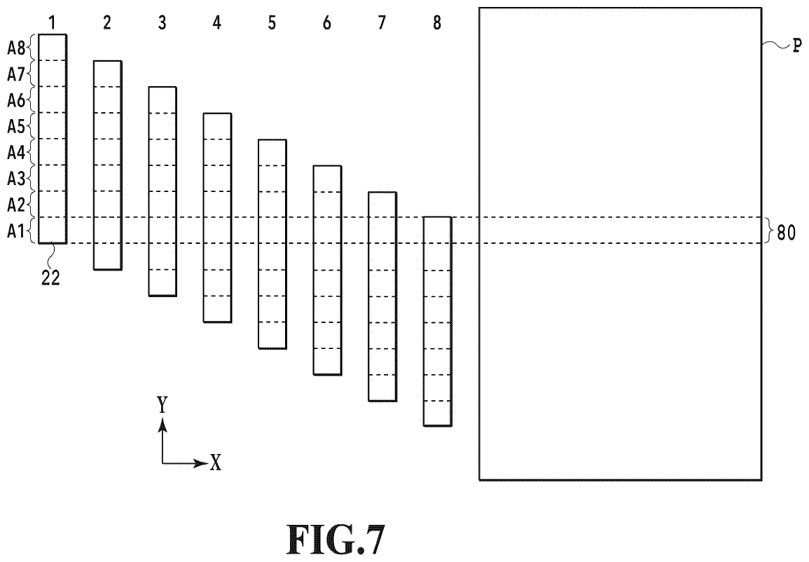

FIG. 7 is a diagram for explaining the multi-path printing conducted in the present embodiment. Here, the inks are ejected from 8 ejection port groups A1 to A8 configured by dividing an ejection port array 22 in the Y-direction in each of the 8 scans on the unit region. Note that although the printing medium P is conveyed to the downstream side in the Y-direction (in the +Y-direction) between the scans of the printing head 9 in practice, FIG. 7 is illustrated such that the printing head 9 is moved to the upstream side in the Y-direction (in the −Y-direction) between the scans for simplicity.

First, in the scan of the first time (first scan), the printing head 9 is caused to scan in the X-direction in a positional relationship in the Y-direction in which a unit region 80 on the printing medium P and the ejection port group A1 in the ejection port array 22 face each other. In addition, the ink is ejected from the ejection port group A1 onto the unit region 80 in accordance with print data corresponding to the first scan. After this first scan ends, the printing medium P is conveyed in the Y-direction by a distance corresponding to one ejection port group. Thereafter, the scan of the second time (second scan) is conducted, and the ink is ejected from the ejection port group A2 onto the unit region 80 in accordance with print data corresponding to the second scan. Subsequently, the conveyance of the printing medium P and the ink ejection from the printing head 9 are alternately conducted to execute the ejection from the ejection port groups A3 to A8 in the scans of the third to eighth times onto the unit region 80. In this way, the multi-path printing onto the unit region 80 is completed.

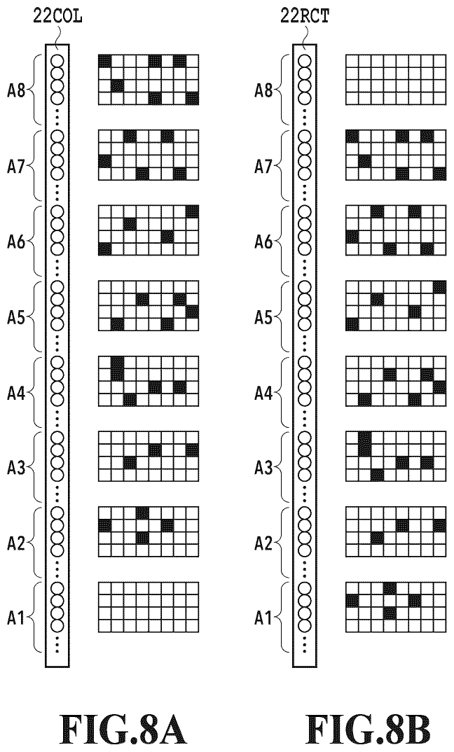

FIG. 8A and FIG. 8B are diagrams showing mask patterns used in the present embodiment. In the mask patterns shown in FIG. 8A and FIG. 8B, black pixels indicate pixels in which ink ejection is allowed in the case where ink ejection is determined by quantization data. On the other hand, white pixels indicate pixels in which ink ejection is not allowed even in the case where ink ejection is determined by quantization data. In FIG. 8A or FIG. 8B, 8 mask patterns each having a size of 4 pixels×8 pixels are shown, and by repeatedly applying these mask patterns in the X-direction and the Y-direction, distribution processing on all the quantization data corresponding to each unit region is conducted.

FIG. 8A shows a mask pattern group to be applied to quantization data corresponding to the ejection port array of the color ink, that is, each of the ejection port array 22C, the ejection port array 22M, the ejection port array 22Y, and the ejection port array 22K. As shown in FIG. 8A, the ejection port groups A1 to A8 of the ejection port array 22COL of the color ink correspond to the scans of the first to eighth times, and pixels where printing is allowed are disposed in the mask patterns corresponding to the ejection port groups A2 to A8 corresponding to the scans of the second to eighth times. On the other hand, in the mask pattern corresponding to the ejection port group A1 corresponding to the scan of the first time, pixels where printing is allowed are not disposed. Hence, in the present example, the color ink is not ejected in the scan of the first time among the 8 scans, and is ejected in the scans of the second to eighth times.

FIG. 8B shows a mask pattern group to be applied to quantization data corresponding to the ejection port array 22RCT of the reaction liquid. As shown in FIG. 8B, the ejection port groups A1 to A8 of the ejection port array 22RCT of the reaction liquid correspond to the scans of the first to eighth times, and pixels where printing is allowed are disposed in the mask patterns corresponding to the ejection port groups A1 to A7 corresponding to the scans of the first to seventh times. On the other hand, in the mask pattern corresponding to the ejection port group A8 corresponding to the scan of the eighth time, pixels where printing is allowed are not disposed. Hence, in the present example, the reaction liquid is ejected in the scans of the first to seventh times among the 8 scans, and is not ejected in the scan of the eighth time.

As described above, in the present embodiment, before the color ink is applied, the reaction liquid is applied onto the printing medium. For this reason, once the color ink is applied onto the printing medium, the color ink instantly comes into contact with the reaction liquid, and accordingly, agglomeration of the pigment immediately starts. As a result, the bleeding of the color ink can be favorably reduced.

Once the printing medium on which the color inks and the reaction liquid have been printed is conveyed and passed through the heater 10, the inks on the printing medium are heated and dried by the heater 10. This fixes the inks on the printing medium, and the printing is completed.

### <Printing Medium>

While the printing apparatus 100 according to the present embodiment is capable of printing on printing media of multiple types, the printing media on which printing is possible by the printing apparatus 100 are classified into printing media having a low absorbance of a water content contained in an ink and printing media having a high absorbance of a water content.

Printing media having a low absorbance include a printing medium in which a plastic layer is formed on the most front surface of a base material, a printing medium in which an ink receiving layer is not formed on a base material, or a sheet, a film, a banner, and the like of glass, YUPO, plastic, and the like. Specific examples of the aforementioned plastic (to be applied) include polyvinyl chloride, polyethylene terephthalate, polycarbonate, polystyrene, polyurethane, polyethylene, polypropylene, and the like. These printing media having a low absorbance are excellent in water resistance, lightfastness, and scratch resistance, and thus are generally used in printing printed products for outdoor exhibitions.

On the other hand, printing media having a high absorbance are printing media in which an ink receiving layer is formed on a front surface of a base material, and include, for example, plain paper, glossy paper, and the like. These printing media are inferior to printing media having a low absorbance in terms of water resistance, lightfastness, and scratch resistance, but can absorb an applied ink in the ink receiving layer and thus are excellent in color productivity, enabling printing with a high image quality. Thus, these printing media are generally used in printing printed products for indoor exhibitions

### <Image Processing>

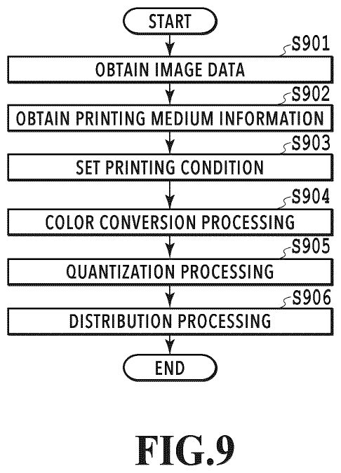

Hereinafter, image processing according to the present embodiment, specifically processing of generating print data to be used in printing by the printing head will be described by using FIG. 9. FIG. 9 is a flowchart of the image processing according to the present embodiment. Note that the processing of each step in FIG. 9 is conducted by the CPU 301 of the printing apparatus 100 developing the control program, which is stored in the ROM 302, in the RAM 303 and executing the developed program.

First, in step S901, the CPU 301 obtains image data inputted from the PC 312, which is the host terminal. Note that in the present embodiment, the image data obtained in the present step is image data in bitmap format in which each pixel is expressed by an RGB value (that is, of 3 channels). In addition, in the following, “step S . . . ” is abbreviated as “S . . . ” for simplicity.

In S902, the CPU 301 obtains printing medium information, specifically, information on the type of printing medium used in printing. In the present embodiment, the user selects the printing medium used in printing, and the CPU 301 obtains information based on the input by the user as information on the type of printing medium.

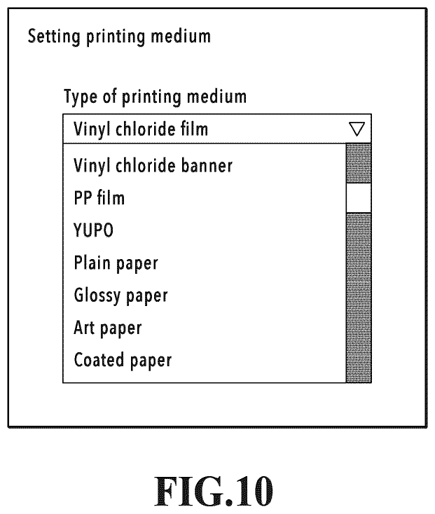

FIG. 10 is a diagram schematically showing a graphical user interface screen (hereinafter referred to as the GUI screen) displayed on a display of the PC 312 in the case where the user inputs information on the type of printing medium. The CPU that the PC 312 has functions as a display control unit configured to display the GUI screen on the display. In the GUI screen shown in FIG. 10, 8 types of printing media, that is, “vinyl chloride film”, “vinyl chloride banner”, “PP film”, “YUPO”, “plain paper”, “glossy paper”, “art paper”, and “coated paper” are displayed. The user selects one printing medium to conduct printing from among a plurality of printing media including at least these 8 types. Then, the PC 312 transmits information on the selected printing medium to the printing apparatus 100, and this information is inputted into the printing apparatus 100 and obtained in S902.

Note that although the mode in which the user inputs information on the type of printing medium to conduct printing via the GUI screen is described here, the present embodiment is not limited to this mode. For example, a mode in which a sensor for judging the type of printing medium is included in the printing apparatus, and information on the type of printing medium is automatically obtained in accordance with a result of determination of the sensor may be employed. In addition, a configuration that enables the user to newly register a type of printing medium in addition to the types (8 types) of printing media registered in advance may be included.

In S903, the CPU 301 selectively sets one printing condition from among a plurality of printing conditions based on the information on the type of printing medium obtained in S902. Among the aforementioned 8 types of printing media, “vinyl chloride film” and “vinyl chloride banner” are printing media in which a layer of polyvinyl chloride is formed on a base material. In addition, “PP film” is a film formed of polypropylene, and “YUPO” is synthetic paper using polypropylene as a raw material. Since these 4 types of printing media have a low absorbance, in the case where information indicating one of these 4 types is obtained in S902 as information on the printing medium to be used in printing, a printing condition for printing media having a low absorbance is set in S903. On the other hand, “plain paper”, “glossy paper”, “art paper”, and “coated paper” generally have a high absorbance. Hence, in the case where information indicating a printing medium of one of these 4 types is obtained in S902 as information on the printing medium to be used in printing, a printing condition for printing media having a high absorbance is set in S903.

In S904, the CPU 301 executes color conversion processing of converting image data expressed by values (RGB value) indicated by RGB signal (image data of 3 channels) into multi-value data corresponding to each ink · reaction liquid used in the image printing. The color conversion processing of the present step generates multi-value data represented by information of 8 bits: 256 values which determines the gradation of each ink in each pixel of a pixel group including a plurality of pixels. This color conversion processing uses a look-up table (referred to as LUT) that specifies a correspondence relationship between an RGB value before conversion and a value represented by a CMYK signal corresponding to each color of color inks after conversion (CMYK value) or a value represented by a signal of a reaction liquid (RCT value). Note that in the present embodiment, the color conversion processing is executed by using LUT that is different depending on the printing condition set in S903.

In S905, the CPU 301 executes quantization processing of quantizing the multi-value data obtained in S904. The quantization processing of the present step generates quantization data represented by information of 1 bit: 2 values which determines ejection (1) or non-ejection (0) of each ink on each pixel. Note that as the method for quantization, a method such as dither processing or error diffusion processing can be employed.

In S906, the CPU 301 executes distribution processing of distributing the quantization data obtained in S905 to a plurality of times of scans of the printing head in the multi-path printing, which has been described by using FIG. 7 as well as FIG. 8A and FIG. 8B. The distribution processing of the present step generates print data represented by information of 1 bit: 2 values which determines ejection or non-ejection of each ink on each pixel in each of the channels) In plurality of times of scans on the unit region on the printing medium.

Note that although the mode in which the CPU 301 in the printing apparatus 100 executes all the processing of S901 to S906 has been described here, the present embodiment is not limited to this mode. For example, a mode in which the CPU in the PC 312 executes some or all of the processing of S901 to S906 may also be employed. For example, a mode in which the PC 312 executes the processing up to the color conversion processing (S1804) and the printing apparatus 100 executes the quantization processing (S1805) and the following may be employed.

### <Maintenance Control Conducted While Printing Operation Is Paused and Tiled Printing>

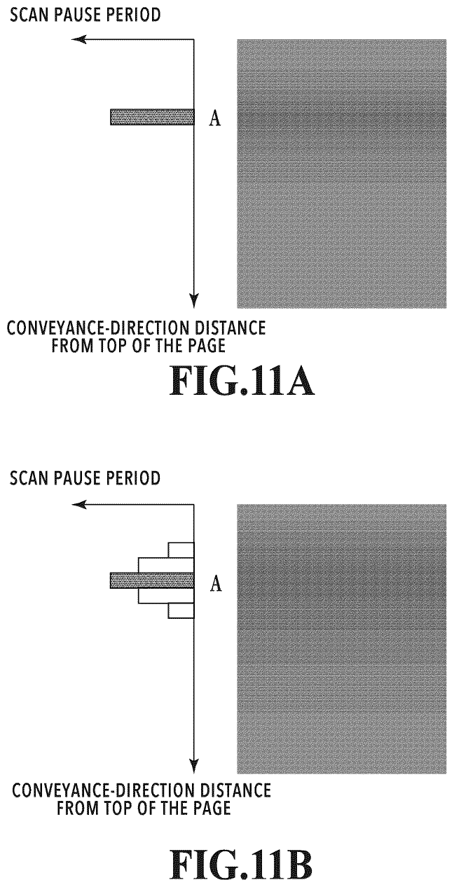

Hereinafter, the maintenance control and unevenness at the time of the tiled printing according to the present embodiment will be described by using FIG. 11A and FIG. 11B. The maintenance control is a control for maintaining or recovering the ejection performance of the printing head, and can be conducted before the printing operation or during printing. In the case of conducting the maintenance control during printing, the maintenance control is conducted while the printing operation is paused. The tiled printing refers to printing an image in which a plurality of output products (printed products) obtained by printing are assumed to be arranged and posted adjacent to each other, while dividing the image into a plurality of pages including at least a first page and a second page. Whether or not to conduct the tiled printing is determined in accordance with the selection by the user. A printed product of the second page has a side which is assumed to be arranged in contact with one side of a printed product of the first page. Note that in the case of executing the tiled printing, the maintenance control may be executed before the start of the page printing operation or may be executed during the page printing operation.

FIG. 11A and FIG. 11B are schematic diagrams showing a relationship between the maintenance control conducted while the printing operation is paused according to the present embodiment and unevenness generated in a printed image.

The left side of FIG. 11A is a graph showing a relationship between a conveyance-direction distance from the top of the page and a scan pause period. It can be seen from this graph that a scan pause period of a certain period of time is generated at a position away from the top of the page by a distance A. This means that the print scan is temporarily paused and a predetermined maintenance control is conducted at the position of the distance A during the page printing. This maintenance control includes at least one of a suction control of sucking the ink from the printing head 9, a discharge control of discharging the ink preliminarily ejected and accumulated in the cap 62, and a wiping-off control (wiping control) of wiping off the ejection port face of the printing head 9 with the sheet member 64.

The right side of FIG. 11A corresponds to the graph on the left side and shows the state of unevenness generated in the printed image (this unevenness is defined as “print scan pause unevenness” because this unevenness is generated due to the pause of the print scan). It can be seen that the density of the printed image is slightly thicker at the position away from the top of the page by the distance A.

The left side of FIG. 11B indicates that scan pause of a certain period of time is generated in the scan at the position away from the top of the page by the distance A as in the case of FIG. 11A and that scan pause (note that the scan pause period of this scan pause is shorter than the certain period of time) is conducted also in two scans before and after the above scan. While scan pause for the maintenance control is conducted in the scan at the position of the distance A, the scan pause which does not involve the maintenance control is conducted in two scans before and after the above scan each, so that the scan pause period gradually decreases from the position of the distance A as the peak. It is known that by providing a gradually decreasing scan pause period in scans before and after scan in which scan pause for the maintenance control is generated, print scan pause unevenness which would be generated in a printed image can be suppressed (see the right side of FIG. 11A and the right side of FIG. 11B). Note that although in FIG. 11A and FIG. 11B, the print scan pause unevenness is described as density unevenness in which the density becomes thicker at the position at which scan pause for the maintenance control is conducted, unevenness is not limited to this. For example, there can also be cases where the density becomes thinner depending on the properties of the ink or the printing medium or generation of change in gloss property looks like unevenness.

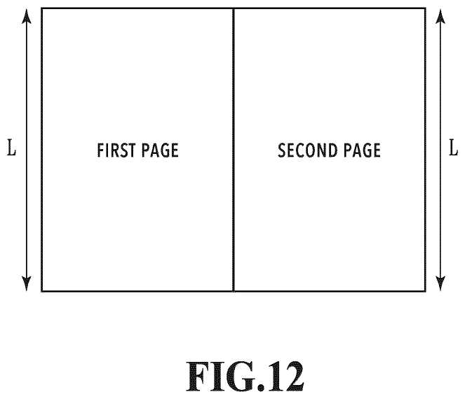

FIG. 12 is a schematic diagram showing a printed product (hereinafter, referred to as a tiled-print product) obtained by the tiled printing according to the present embodiment. The first page on the left side and the second page on the right side are each a printed product printed with the width of the printing medium P set in the printing apparatus 100 according to the present embodiment, and are posted adjacent as shown in FIG. 12 to complete one image.

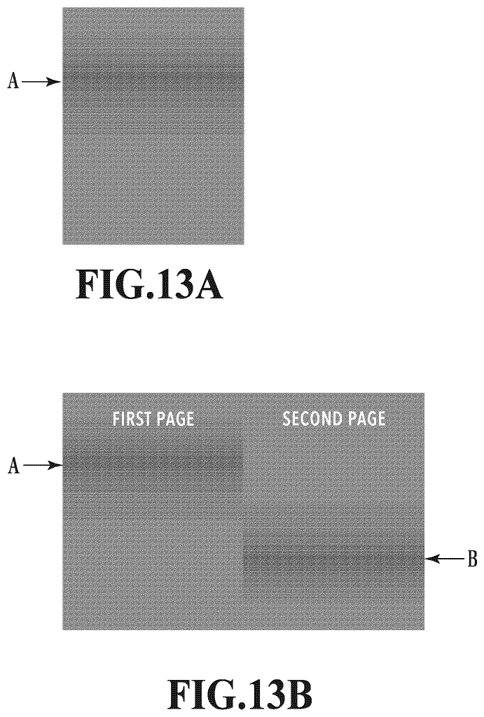

Here, for reference, a conventional technique to which the present embodiment is not applied will be described. In the conventional technique, there has been a case where the maintenance control, which is conducted while the printing operation is paused in each of the printing of a first page and the printing of a second page, is conducted at different positions in the respective pages (that is, at different distances from the top of the page). As shown in FIG. 13B, in the case where the maintenance control is conducted at a position away from the top of the page by a distance A in the printing of the first page while the maintenance control is conducted at a position away from the top of the page by a distance B in the printing of the second page, unevenness is visually observed in a portion where the first page and the second page are adjacent to each other. That is, FIG. 13B indicates that unevenness which is unlikely to be visually recognized in the case where the first page is posted alone as shown in FIG. 13A are made visually recognizable by posting the first page and the second page, which are obtained as tiled-print products, adjacent to each other. An object of the present embodiment is to suppress such unevenness.

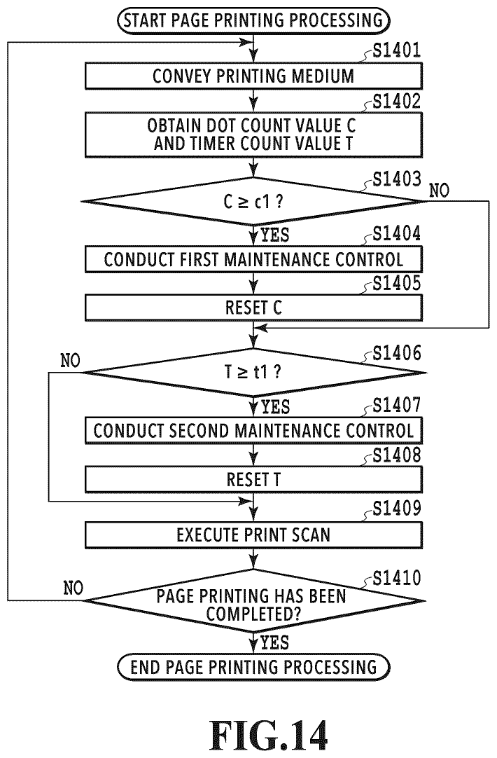

Hereinafter, the maintenance control according to the present embodiment which is conducted to suppress print scan pause unevenness in tiled printing will be described by using FIG. 14 to FIG. 16B.

First, as the premise, a page printing operation involving a maintenance control which is conducted while the printing operation is paused in the case of not tiled printing but normal printing will be described by using FIG. 14.

Note that in the following, the case where there are two types of predetermined maintenance controls which generate print scan pause unevenness will be described. Specifically, the first maintenance control is a discharge control of discharging the ink preliminarily ejected and accumulated in the cap 62. This maintenance control is a control in which the number of ejected ink droplets which are preliminarily ejected into the cap is calculated by dot-counting ejection signals, and the print scan is paused to conduct discharge at a timing at which the accumulated value exceeds a predetermined threshold, and is defined as a “first maintenance control”. The second maintenance control is a wiping-off control of wiping off the ejection port face of the printing head 9 with the sheet member 64. This maintenance control is a control in which the elapsed period after the conducting of the previous wiping-off control is counted, and the print scan is paused to conduct wiping at a timing at which the counted value exceeds a predetermined threshold, and is defined as a “second maintenance control”.

The page printing processing of FIG. 14 starts in the case where the printing apparatus 100 has received a printing instruction transmitted by the PC 312.

In S1401, the CPU 301 conveys the printing medium P. By the conveyance of the present step, the printing medium P is guided to a position on the platen 4, which is a printing position facing the printing head 9.

In S1402, the CPU 301 obtains a dot count value C which is a count value regarding the first maintenance control and a timer count value T which is a count value regarding the second maintenance control.

In S1403, the CPU 301 determines whether the dot count value C is equal to or more than a predetermined threshold c1. In the case where the result of determination of the present step is true, the CPU 301 proceeds to S1404. On the other hand, in the case where the result of determination of the present step is false, the CPU 301 proceeds to S1406.

In S1404, the CPU 301 conducts the first maintenance control.

In S1405, the CPU 301 resets the dot count value C (makes the dot count value C zero).

In S1406, the CPU 301 determines whether the timer count value T is equal to or more than a predetermined threshold t1. In the case where the result of determination of the present step is true, the CPU 301 proceeds to S1407. On the other hand, in the case where the result of determination of the present step is false, the CPU 301 proceeds to S1409.

In S1407, the CPU 301 conducts the second maintenance control.

In S1408, the CPU 301 resets the timer count value T (makes the timer count value T zero).

In S1409, the CPU 301 executes the print scan.

In S1410, the CPU 301 determines whether the page printing has been completed. In the case where the result of determination of the present step is true, the CPU 301 ends the series of page printing processing. On the other hand, in the case where the result of determination of the present step is false, the CPU 301 returns to S1401 and continues the page printing processing.

The above is the content of the page printing operation involving the maintenance control which is conducted while the printing operation is paused in the case of not the tiled printing but the normal printing.

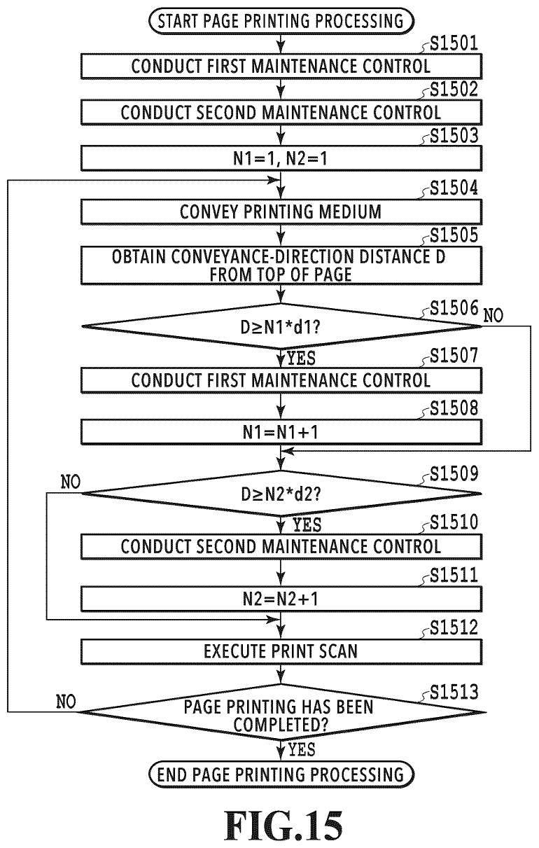

Subsequently, a page printing operation involving a maintenance control which is conducted while the printing operation is paused in the case of tiled printing will be described by using FIG. 15. Note that in the following, the case where there are two types of predetermined maintenance controls (the first maintenance control and the second maintenance control) which generate print scan pause unevenness will be described as in the case of FIG. 14.

The page printing processing of FIG. 15 starts in the case where the printing apparatus 100 has received a printing instruction transmitted by the PC 312.

In S1501, the CPU 301 conducts the first maintenance control.

In S1502, the CPU 301 conducts the second maintenance control.

In S1503, the CPU 301 sets 1 in a parameter N1 which indicates the number of times of conducting the first maintenance control on pages during printing, and sets 1 in a parameter N2 which indicates the number of times of conducting the second maintenance control on the pages during printing.

In S1504, the CPU 301 conveys the printing medium P. By the conveyance of the present step, the printing medium P is guided to a position on the platen 4, which is a printing position facing the printing head 9.

In S1505, the CPU 301 obtains a conveyance-direction distance D from the top of the page on the page during printing.

In S1506, the CPU 301 determines whether D≥N1×d1 is satisfied. Here, d1 is a parameter indicating after how much the conveyance-direction distance proceeds, the first maintenance control is conducted every time. In this way, in the present embodiment, the CPU 301 determines whether to conduct the maintenance control based on a size relationship between the conveyance-direction distance D and a predetermined distance using the leading end of the page as a reference (zero). In the case where the result of determination of the present step is true, the CPU 301 proceeds to S1507. On the other hand, in the case where the result of determination of the present step is false, the CPU 301 proceeds to S1509.

In S1507, the CPU 301 conducts the first maintenance control.

In S1508, the CPU 301 adds 1 to (counts up) N1.

In S1509, the CPU 301 determines whether D≥N2×d2 is satisfied. Here, d2 is a parameter indicating after how much the conveyance-direction distance proceeds, the second maintenance control is conducted every time, and satisfies a relationship of d2>d1. In the case where the result of determination of the present step is true, the CPU 301 proceeds to S1510. On the other hand, in the case where the result of determination of the present step is false, the CPU 301 proceeds to S1512.

In S1510, the CPU 301 conducts the second maintenance control.

In S1511, the CPU 301 adds 1 to (counts up) N2.

In S1512, the CPU 301 executes the print scan.

In S1513, the CPU 301 determines whether the page printing has been completed. In the case where the result of determination of the present step is true, the CPU 301 ends the series of page printing processing. On the other hand, in the case where the result of determination of the present step is false, the CPU 301 returns to S1501 and continues the page printing processing.

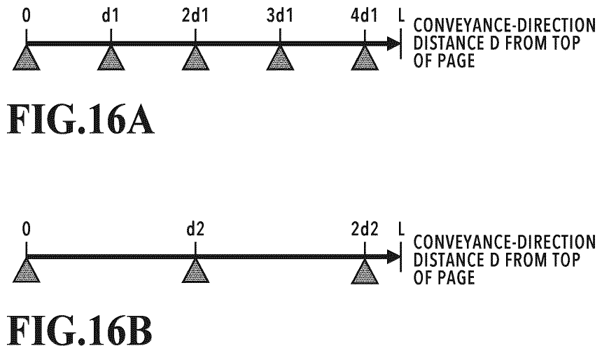

In the present embodiment, the printing operation shown in FIG. 15 is conducted at the time of tiled printing. With this, the relationship between the distance from the top of the page which causes the print scan pause unevenness of the first maintenance control conducted at the time of printing each page and the distance from the top of the page which causes the print scan pause unevenness of the second maintenance control conducted at the time of printing each page is as shown in FIG. 16A and FIG. 16B.

FIG. 16A and FIG. 16B are described. FIG. 16A indicates that the first maintenance control is conducted at a position at which the conveyance-direction distance is d1, 2d1, 3d1, or 4d1 on each page, where L represents the conveyance-direction length of the printed image. In addition, FIG. 16B indicates that the second maintenance control is conducted at a position at which the conveyance-direction distance is d2 or 2d2 on each page, where L represents the conveyance-direction length of the printed image. Note that as shown in FIG. 16A, the present embodiment satisfies d1<d2.

As described above, in the present embodiment, a predetermined maintenance control which generates print scan pause unevenness is conducted based on the distance from the top of the page in the case of printing any page at the time of tiled printing. This makes it possible to align the conveyance-direction positions at which print scan pause unevenness is generated between pages which are adjacent in the case where the pages are posted. Hence, it becomes possible to make unevenness attributable to pause of print scan, which is unevenness easily visually recognized in a joint portion in the conventional technique, unlikely to be visually recognized.

### Second Embodiment

The present embodiment has a similar configuration to the first embodiment, but is different in the tiled printing method. This point will be described by using FIG. 15 and FIGS. 17 to 20.

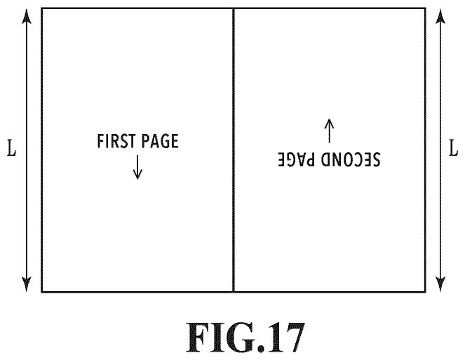

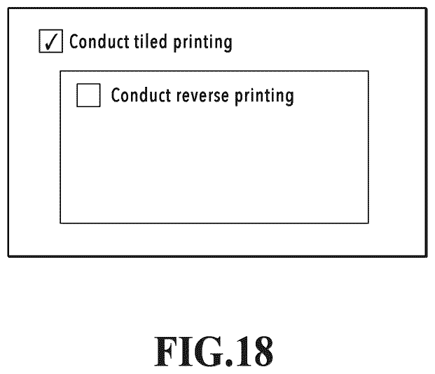

FIG. 17 is a schematic diagram showing a tiled-print product according to the present embodiment. The first page on the left side and the second page on the right side are each a printed product printed with the width of the printing medium P set in the printing apparatus 100 according to the present embodiment, and are posted adjacent as shown in FIG. 17 to complete one image. A difference between the present embodiment and the first embodiment (see FIG. 7) is that an even number page is printed in the state of being reversed by 180 degrees. The printing method for such printing is a method assuming the case where the density of an image varies depending on the position in the scanning direction of the printing apparatus, and the user can select whether or not to conduct the reverse printing via a GUI screen as shown in FIG. 18.

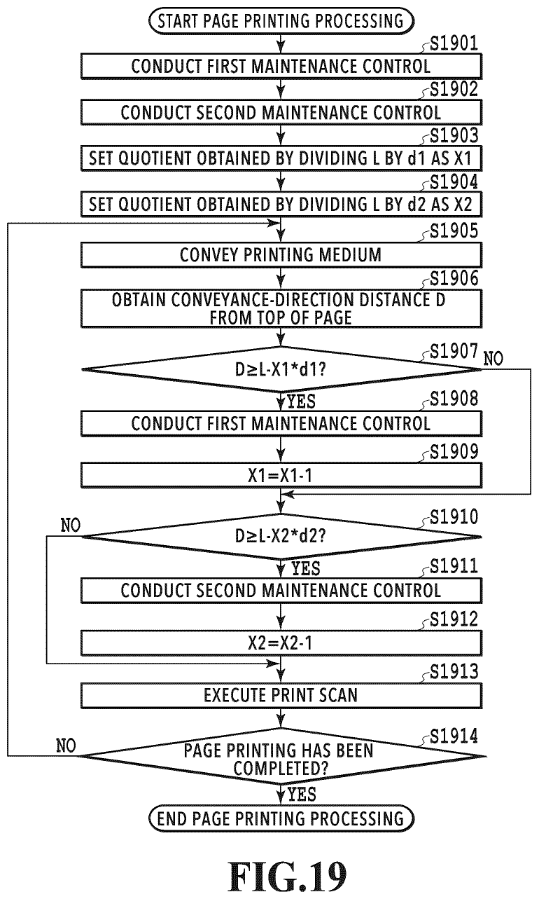

The printing operation at the time of tiled printing of an odd number page is the same as in the first embodiment and will not be described (see FIG. 15). Hereinafter, the printing operation of an even number page according to the present embodiment will be described by using FIG. 19.

The page printing processing of FIG. 19 starts when the printing apparatus 100 has received a printing instruction transmitted by the PC 312.

In S1901, the CPU 301 conducts the first maintenance control.

In S1902, the CPU 301 conducts the second maintenance control.

In S1903, the CPU 301 calculates a parameter X1 which corresponds to the number of times according to the first maintenance control in accordance with formula (1). That is, the CPU 301 calculates a quotient by dividing the length L of the printed image by d1, and obtains the calculated quotient as X1.

$$X 1 = QUOTIENT ( L , d 1 ) \qquad formula ( 1 )$$

In S1904, the CPU 301 calculates a parameter X2 which corresponds to the number of times according to the second maintenance control in accordance with formula (2). That is, the CPU 301 calculates a quotient by dividing the length L of the printed image by d2, and obtains the calculated quotient as X2.

$$X 2 = QUOTIENT ( L , d 2 ) \qquad formula ( 2 )$$

In S1905, the CPU 301 conveys the printing medium P. By the conveyance of the present step, the printing medium P is guided to a position on the platen 4, which is a printing position facing the printing head 9.

In S1906, the CPU 301 obtains a conveyance-direction distance D from the top of the page on the page during printing.

In S1907, the CPU 301 determines whether D≥L−X1*d1 is satisfied. In this way, in the present embodiment, the CPU 301 determines whether to conduct the maintenance control based on a size relationship between the conveyance-direction distance D and a predetermined distance using the trailing end of the page as a reference (zero). In the case where the result of determination of the present step is true, the CPU 301 proceeds to S1908. On the other hand, in the case where the result of determination of the present step is false, the CPU 301 proceeds to S1910.

In S1908, the CPU 301 conducts the first maintenance control.

In S1909, the CPU 301 subtracts 1 from (counts down) X1.

In S1910, the CPU 301 determines whether D>L−X2*d2 is satisfied. In the case where the result of determination of the present step is true, the CPU 301 proceeds to S1911. On the other hand, in the case where the result of determination of the present step is false, the CPU 301 proceeds to S1913.

In S1911, the CPU 301 conducts the second maintenance control.

In S1912, the CPU 301 subtracts 1 from (counts down) X2.

In S1913, the CPU 301 executes the print scan.

In S1914, the CPU 301 determines whether the page printing has been completed. In the case where the result of determination of the present step is true, the CPU 301 ends the series of page printing processing. On the other hand, in the case where the result of determination of the present step is false, the CPU 301 returns to S1905 and continues the page printing processing.

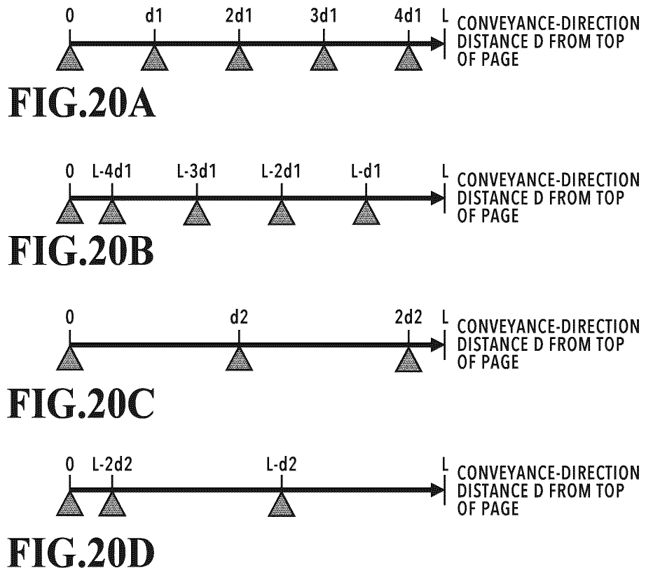

In the present embodiment, at the time of tiled printing corresponding to reverse, the printing operation shown in FIG. 15 is conducted on an odd number page, and the printing operation shown in FIG. 19 is conducted on an even number page. With this, the relationship between the distance from the top of the page which causes the print scan pause unevenness of the first maintenance control conducted at the time of printing each page and the distance from the top of the page which causes the print scan pause unevenness of the second maintenance control conducted at the time of printing each page is as shown in FIG. 20A to FIG. 20D.

FIG. 20A to FIG. 20D are described. FIG. 20A indicates that the first maintenance control is conducted at a position at which the conveyance-direction distance is d1, 2d1, 3d1, or 4d1 on an odd number page, where L represents the conveyance-direction length of the printed image. In addition, FIG. 20C indicates that the second maintenance control is conducted at a position at which the conveyance-direction distance is d2 or 2d2 on an odd number page, where L represents the conveyance-direction length of the printed image.

FIG. 20B indicate that the first maintenance control is conducted at a position at which the conveyance-direction distance is L-4d1, L-3d1, L-2d1, or L-d1 on an even number page, where L represents the conveyance-direction length of the printed image. In addition, FIG. 20D indicate that the second maintenance control is conducted at a position at which the conveyance-direction distance is L-2d2 or L-d2 on an even number page, where L represents the conveyance-direction length of the printed image.

As described above, in the present embodiment, at the time of tiled printing corresponding to reverse, a predetermined maintenance control which generates print scan pause unevenness is conducted based on the distance from the top of the page, and the content of the conduct is switched between an odd number page and an even number page. This makes it possible to align the conveyance-direction positions at which print scan pause unevenness is generated between pages which are adjacent in the case where the pages are posted. Hence, it becomes possible to make unevenness attributable to pause of print scan, which is unevenness easily visually recognized in a joint portion in the conventional technique, unlikely to be visually recognized.

### Third Embodiment

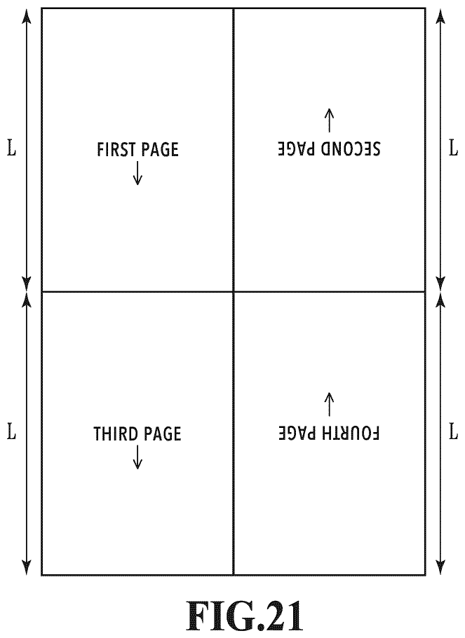

The present embodiment has a similar configuration to the first embodiment and the second embodiment, but is different in the tiled printing method. This point will be described by using FIGS. 21 to 26.

FIG. 21 is a schematic diagram showing a tiled-print product according to the present embodiment. A difference between the present embodiment and the first embodiment (FIG. 12) or the second embodiment (FIG. 17) is that printed pages are arrayed also in the conveyance direction (the vertical direction in the drawing) to complete one image. That is, a printed product of the first page and a printed product of the second page are arranged adjacent to each other in a first direction (the lateral direction in the drawing), and printed products of odd number pages including the first page are arranged adjacent to each other in a second direction (the vertical direction in the drawing) orthogonal to the first direction, and printed products of even number pages including the second page are arranged adjacent to each other in the second direction.

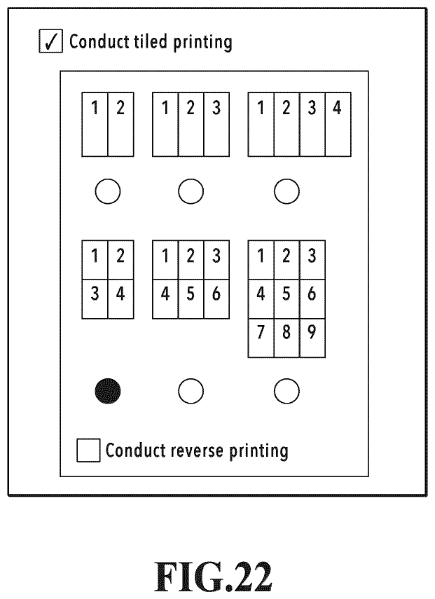

The user can select the arrangement of a plurality of printed pages formed by tiled printing via a GUI screen as shown in FIG. 22. As shown in FIG. 22, in the present example, it is possible to select the case of laterally arranging 2 pages, 3 pages, or 4 pages or the case of vertically and laterally arranging 4 pages, 6 pages, or 9 pages. Note that in the present embodiment, it is assumed that pages adjacent to each other in the lateral direction are printed in a reversed manner as described in the second embodiment (FIG. 17).

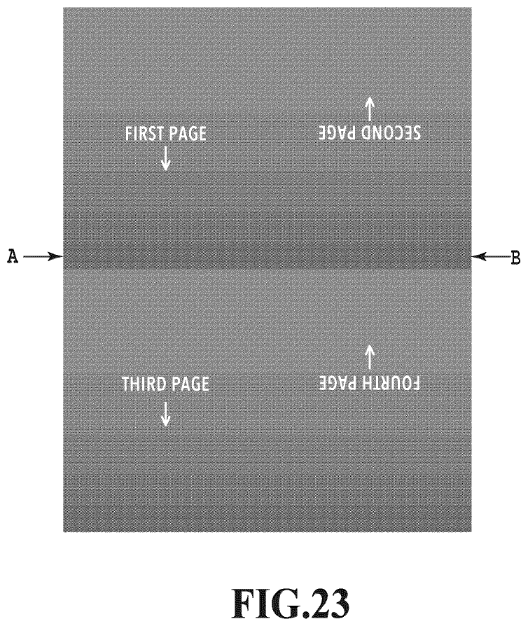

FIG. 23 shows the case where unevenness is visually recognized in a portion in which upper and lower pages are adjacent to each other as a result of not applying the method described in the present embodiment. This scan pause unevenness occurs in the case where a maintenance control involving pausing of the printing operation is conducted near the leading end or the trailing end of a page.

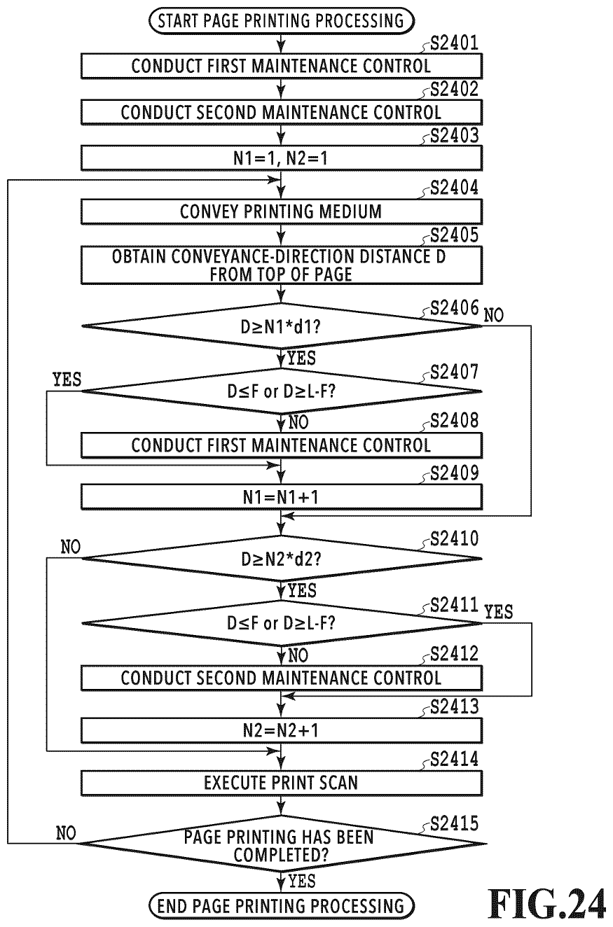

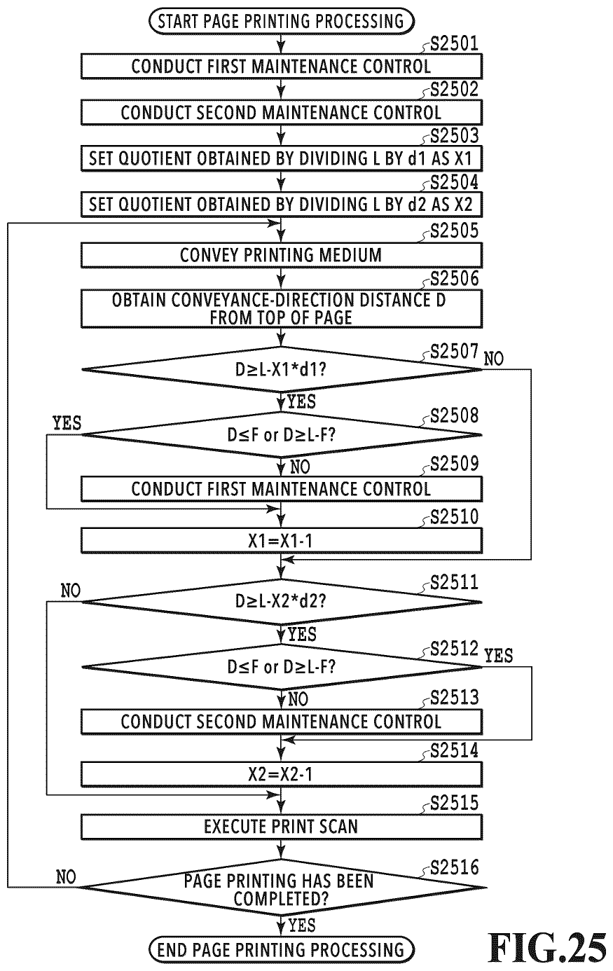

Hereinafter, a page printing operation which is conducted in the present embodiment in order to suppress the aforementioned scan pause unevenness will be described by using FIG. 24 and FIG. 25.

First, a printing operation in the case of conducting tiled printing of an odd number page will be described by using a flowchart of FIG. 24. The page printing processing of FIG. 24 starts when the printing apparatus 100 has received a printing instruction transmitted by the PC 312.

In S2401, the CPU 301 conducts the first maintenance control.

In S2402, the CPU 301 conducts the second maintenance control.

In S2403, the CPU 301 sets 1 in a parameter N1 which indicates the number of times of conducting the first maintenance control on pages during printing, and set 1 in a parameter N2 which indicates the number of times of conducting the second maintenance control on the pages during printing.

In S2404, the CPU 301 conveys the printing medium P. By the conveyance of the present step, the printing medium P is guided to a position on the platen 4, which is a printing position facing the printing head 9.

In S2405, the CPU 301 obtains a conveyance-direction distance D from the top of the page on the page during printing.

In S2406, the CPU 301 determines whether D≥N1×d1 is satisfied. In the case where the result of determination of the present step is true, the CPU 301 proceeds to S2407. On the other hand, in the case where the result of determination of the present step is false, the CPU 301 proceeds to S2410.

In S2407, the CPU 301 determines whether D≤F or D≥L−F is satisfied. Here, F represents a predetermined distance from the leading end portion (the top of the page) or the trailing end portion (the trailing end of the page) of the page, and execution of the present step means prohibiting the conducting of a predetermined maintenance control which generates print scan pause unevenness in a range of the distance F from the leading end (or the trailing end). In the case where the result of determination of the present step is true, the CPU 301 proceeds to S2409. On the other hand, in the case where the result of determination of the present step is false, the CPU 301 proceeds to S2408.

In S2408, the CPU 301 conducts the first maintenance control.

In S2409, the CPU 301 adds 1 to (counts up) N1.

In S2410, the CPU 301 determines whether D≥N2×d2 is satisfied. In the case there the result of determination of the present step is true, the CPU 301 proceeds to S2411. On the other hand, in the case there the result of determination of the present step is false, the CPU 301 proceeds to S2414.

In S2411, the CPU 301 determines whether D≤F or D≥L−F is satisfied. In the case where the result of determination of the present step is true, the CPU 301 proceeds to S2413. On the other hand, in the case where the result of determination of the present step is false, the CPU 301 proceeds to S2412.

In S2412, the CPU 301 conducts the second maintenance control.

In S2413, the CPU 301 adds 1 to (counts up) N2.

In S2414, the CPU 301 executes the print scan.

In S2415, the CPU 301 determines whether the page printing has been completed. In the case where the result of determination of the present step is true, the CPU 301 ends the series of page printing processing. On the other hand, in the case where the result of determination of the present step is false, the CPU 301 returns to S2404 and continues the page printing processing.

The above is the content of the printing operation in the case of conducting tiled printing of an odd number page.

Subsequently, a printing operation in the case of conducting tiled printing of an even number page will be described by using a flowchart of FIG. 25.

The page printing processing of FIG. 25 starts when the printing apparatus 100 has received a printing instruction transmitted by the PC 312.

In S2501, the CPU 301 conducts the first maintenance control.

In S2502, the CPU 301 conducts the second maintenance control.

In S2503, the CPU 301 calculates a parameter X1 which corresponds to the number of times according to the first maintenance control in accordance with the aforementioned formula (1). That is, the CPU 301 calculates a quotient by dividing the length L of the printed image by d1, and obtains the calculated quotient as X1.

In S2504, the CPU 301 calculates a parameter X2 which corresponds to the number of times according to the second maintenance control in accordance with the aforementioned formula (2). That is, the CPU 301 calculates a quotient by diving the length L of the printed image by d2, and obtains the calculated quotient as X2.

In S2505, the CPU 301 conveys the printing medium P. By the conveyance of the present step, the printing medium P is guided to a position on the platen 4, which is a printing position facing the printing head 9.

In S2506, the CPU 301 obtains a conveyance-direction distance D from the top of the page on the page during printing.

In S2507, the CPU 301 determines whether D≥L−x1*d1 is satisfied. In the case where the result of determination of the present step is true, the CPU 301 proceeds to S2508. On the other hand, in the case where the result of determination of the present step is false, the CPU 301 proceeds to S2511.

In S2508, the CPU 301 determines whether D≤F or D≥L−F is satisfied. In the case where the result of determination of the present step is true, the CPU 301 proceeds to S2510. On the other hand, in the case where the result of determination of the present step is false, the CPU 301 proceeds to S2509.

In S2509, the CPU 301 conducts the first maintenance control.

In S2510, the CPU 301 subtracts 1 from (counts down) x1.

In S2511, the CPU 301 determines whether D≥L−X2*d2 is satisfied. In the case where the result of determination of the present step is true, the CPU 301 proceeds to S2512. On the other hand, in the case where the result of determination of the present step is false, the CPU 301 proceeds to S2515.

In S2512, the CPU 301 determines whether D≤F or D≥L−F is satisfied. In the case where the result of determination of the present step is true, the CPU 301 proceeds to S2514. On the other hand, in the case where the result of determination of the present step is false, the CPU 301 proceeds to S2413.

In S2513, the CPU 301 conducts the second maintenance control.

In S2514, the CPU 301 subtracts 1 from (counts down) X2.

In S2515, the CPU 301 executes the print scan.

In S2516, the CPU 301 determines whether the page printing has been completed. In the case where the result of determination of the present step is true, the CPU 301 ends the series of page printing processing. On the other hand, in the case where the result of determination of the present step is false, the CPU 301 returns to S2505 and continues the page printing processing.

The above is the content of the printing operation in the case of conducting tiled printing of an even number page.

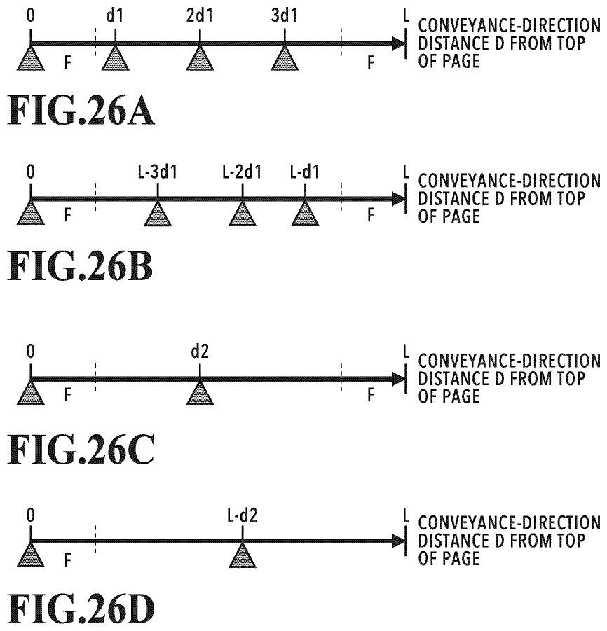

In the present embodiment, at the time of tiled printing in which printed pages are arrayed also in the vertical direction, the printing operation shown in FIG. 24 is conducted on an odd number page, and the printing operation shown in FIG. 25 is conducted on an even number page. With this, the relationship between the distance from the top of the page which causes the print scan pause unevenness of the first maintenance control conducted at the time of printing each page and the distance from the top of the page which causes the print scan pause unevenness of the second maintenance control conducted at the time of printing each page is as shown in FIG. 26A to FIG. 26D.

FIG. 26A indicates that the first maintenance control is conducted at a position at which the conveyance-direction distance is d1, 2d1, or 3d1 and the first maintenance control is not conducted in ranges of F from the leading and trailing ends, on an odd number page, where L represents the conveyance-direction length of the printed image. In addition, FIG. 26C indicates that the second maintenance control is conducted at a position at which the conveyance-direction distance is d2 and the second maintenance control is not conducted in ranges of F from the leading and trailing ends, on an odd number page, where L represents the conveyance-direction length of the printed image.

FIG. 26B indicates that the first maintenance control is conducted at a position at which the conveyance-direction distance is L−3d1, L−2d1, or L−d1 and the first maintenance control is not conducted in ranges of F from the leading and trailing ends, on an even number page, where L represents the conveyance-direction length of the printed image. In addition, FIG. 26D indicates that the second maintenance control is conducted at a position at which the conveyance-direction distance is L−d2 and the second maintenance control is not conducted in ranges of F from the leading and trailing ends, on an even number page, where L represents the conveyance-direction length of the printed image.

According to the present embodiment, even in the case where tiled-print products are arrayed also in the vertical direction, conveyance-direction positions which cause print scan pause unevenness can be aligned between pages adjacent to each other in the vertical direction. Hence, it becomes possible to make unevenness attributable to pause of print scan, which is unevenness easily visually recognized in a joint portion in the conventional technique, unlikely to be visually recognized.

### OTHER EMBODIMENTS

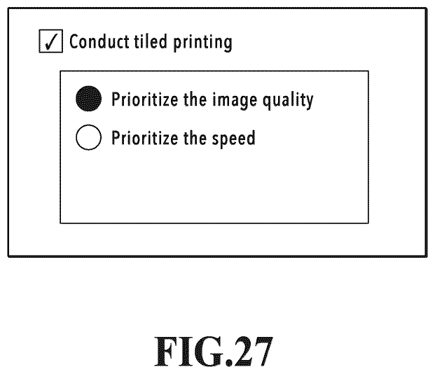

In the aforementioned embodiments, the configuration in which a predetermined maintenance control which is conducted while a printing operation is paused is conducted based on the distance from the top of the page at the time of tiled printing has been described. However, a configuration in which the content of a maintenance control is switched in accordance with the selection of the user at the time of tiled printing as well may be employed. For example, the user can be enabled to select prioritizing the image quality or prioritizing the speed via a GUI screen as shown in FIG. 27. In the case where prioritizing the image quality has been selected, a predetermined maintenance control is conducted based on the distance from the top of the page. On the other hand, in the case where prioritizing the speed has been selected, a predetermined maintenance control can be conducted based on a parameter other than the distance from the top of the page, such as an ejection dot count, a timer count, or the like.

In the case of conducting a predetermined maintenance control based on the distance from the top of the page, it is conceivable that the number of times of the predetermined maintenance control to be conducted in a page becomes larger than the case where a predetermined maintenance control is conducted based on a parameter other than the distance, depending on an image to be printed. In addition, even in tiled printing, there is a case where unevenness is less noticeable in a joint portion in the case of posting, depending on an image to be printed. As mentioned above, by enabling the user to switch the maintenance control as appropriate, it becomes possible to execute tiled printing with the most appropriate image quality and speed suitable for an image to be printed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to suppress density unevenness in a joint portion at the time of tiled printing even in the case of conducting a predetermined maintenance control while pausing a printing operation during image printing.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-172196, filed Oct. 3, 2023, which is hereby incorporated by reference wherein in its entirety.

What is claimed is:

1. A printing apparatus comprising:
a conveyance unit configured to convey a printing medium in a conveyance direction;
a printing head configured to eject a liquid; and
a control unit capable of conducting a maintenance control on the printing head while temporarily pausing a printing operation and configured to execute tiled printing of printing an image in which a plurality of printed products obtained by printing are assumed to be arranged adjacent to each other, while dividing the image into a plurality of pages including at least a first page and a second page, the control unit being configured to control whether or not to conduct the maintenance control based on a conveyance-direction distance from a top of the page along the conveyance direction for the page during printing in a case of executing the tiled printing and printing each of the plurality of pages.

2. The printing apparatus according to claim 1, wherein a printed product of the second page has a side which is assumed to be arranged in contact with one side of a printed product of the first page.

3. The printing apparatus according to claim 1, wherein in the tiled printing, in a case of printing an even number page including the second page which is assumed to be arranged adjacent to an odd number page including the first page, the printing apparatus is capable of conducting reverse printing in which an image of the even number page is printed in a reversed manner relative to an image of the odd number page.

4. The printing apparatus according to claim 3, wherein in a case of executing the reverse printing, the printing apparatus conducts the maintenance control based on the conveyance-direction distance and a predetermined distance with respect to a top of the page as a reference in a case of printing the odd number page, and conducts the maintenance control based on the conveyance-direction distance and a predetermined distance with respect to a trailing end of the page as a reference in a case of printing the even number page.

5. The printing apparatus according to claim 3, wherein
a printed product of the first page and a printed product of the second page are arranged adjacent to each other in a first direction,
printed products of odd number pages including the first page are arranged adjacent to each other in a second direction orthogonal to the first direction, and
printed products of even number pages including the second page are arranged adjacent to each other in the second direction.

6. The printing apparatus according to claim 5, wherein
for each of the plurality of pages, the printing apparatus does not conduct the maintenance control in a range of a predetermined distance from the top of the page along the conveyance direction, and
for each of the plurality of pages, the printing apparatus does not conduct the maintenance control in a range of a predetermined distance from a trailing end of the page along the conveyance direction.

7. The printing apparatus according to claim 5, wherein
the printing apparatus is connected to an information processing apparatus, and
the information processing apparatus includes a display control unit configured to display a graphical user interface screen.

8. The printing apparatus according to claim 7, wherein a user can select whether or not to conduct the tiled printing via the graphical user interface screen.

9. The printing apparatus according to claim 8, wherein in a case of conducting the tiled printing, the user can select whether or not to conduct the reverse printing via the graphical user interface screen.

10. The printing apparatus according to claim 9, wherein in the case of conducting the tiled printing, the user can select arrangement of the plurality of pages via the graphical user interface screen.

11. The printing apparatus according to claim 1, wherein in a case of executing the tiled printing, the printing apparatus conducts the maintenance control before starting a page printing operation.

12. The printing apparatus according to claim 1, wherein a scan pause period at a position at which the maintenance control is conducted is longer than scan pause periods at positions for scans before and after a scan corresponding to the position at which the maintenance control is conducted.

13. The printing apparatus according to claim 1, wherein the maintenance control includes at least one of a suction control of sucking the liquid from the printing head, a discharge control of discharging the liquid preliminarily ejected and accumulated in a cap, and a wiping control of wiping off an ejection port face of the printing head with a sheet member.

14. A method for controlling a printing apparatus including:
a conveyance unit configured to convey a printing medium in a conveyance direction;
a printing head configured to eject a liquid; and
a control unit capable of conducting a maintenance control on the printing head while temporarily pausing a printing operation and configured to execute tiled printing of printing an image in which a plurality of printed products obtained by printing are assumed to be arranged adjacent to each other, while dividing the image into a plurality of pages including at least a first page and a second page,
the method comprising:
controlling whether or not to conduct the maintenance control based on a conveyance-direction distance from a top of the page along the conveyance direction for the page during printing in a case where the control unit executes the tiled printing and prints each of the plurality of pages.

15. A non-transitory computer readable storage medium storing a program configured to cause a computer to execute a method for controlling a printing apparatus including:
a conveyance unit configured to convey a printing medium in a conveyance direction;
a printing head configured to eject a liquid; and
a control unit capable of conducting a maintenance control on the printing head while temporarily pausing a printing operation and configured to execute tiled printing of printing an image in which a plurality of printed products obtained by printing are assumed to be arranged adjacent to each other, while dividing the image into a plurality of pages including at least a first page and a second page,
the method comprising:
controlling whether or not to conduct the maintenance control based on a conveyance-direction distance from a top of the page along the conveyance direction for the page during printing in a case where the control unit executes the tiled printing and prints each of the plurality of pages.
